(19) United States
(12) Patent Application Publication
(10) Pub. No.: US 2026/0253435 A1
(43) Pub. Date: Aug. 27, 2026

(54) ANIMAL EXPERIMENTAL ANALYSIS SYSTEM CONSISTING OF MULTIPLE SDK-BASED MODULES

(71) Applicant: ACTNOVA INC., Daejeon (KR)

(72) Inventors: Jong Whoa Lee, Seoul (KR); Ho Chan Jo, Seoul (KR)

(73) Assignee: ACTNOVA INC., Daejeon (KR)

(21) Appl. No.: 19/217,054

(22) Filed: May 23, 2025

(30) Foreign Application Priority Data
Feb. 24, 2025 (KR) 10-2025-0023483

(51) Int. Cl. G06V 20/70; G06F 21/31; G06T 7/70; G06V 40/20

(52) U.S. Cl. CPC G06V 20/70; G06F 21/31; G06T 7/70; G06V 40/20

(57) ABSTRACT

The present specification relates to a terminal for performing animal analysis, through a software development kit (SDK) module, which may include: an Auth SDK module configured to perform user authentication, and acquire a token for server access through a Resource Access Manager; a UI SDK module configured to visually represent a result of the animal analysis, and perform a component manipulation, a learning result visualization or an analysis result visualization function; an AI SDK module configured to perform labeling, learning, prediction and analysis functions for the animal analysis, including pose estimation and behavior analysis functions; and a Data SDK module configured to synchronize data between the terminal and the server, and store and retrieve data related to the animal analysis.

### BACKGROUND FIELD

The present specification relates to an animal experimental analysis system consisting of a plurality of software development kit (SDK)-based modules.

### DESCRIPTION OF RELATED ART

In providing a service to a user, providing autonomy to the user has the advantage of allowing the service to be utilized in a variety of ways, thereby expanding the range of choices. However, when technical background knowledge is required, it may be time consuming for the user to fully understand and utilize the service. In particular, in the case of animal behavior analysis, various setting options may be provided, such as selection of a model for pose estimation, determination of a clustering analysis algorithm, selection of a reference point for analyzing animal movement (e.g., center of mass or head), and definition of the concept of entry into a specific spatial region (e.g., movement of the center of mass or entry of a body part).

However, since exposing all options to the user may increase the complexity of service usage, a method of restricting the user's usage of the service based on the setting value of the provider should be considered. In this way, instead of reducing the degree of freedom of the user, an effect of facilitating use of the service may be obtained. It is important to maintain a balance between these degrees of freedom and convenience, and for this purpose, a manner of developing an existing product in the form of an SDK is suitable. Through the SDK, the user may freely utilize or customize specific functions at the code level, while also conveniently using basic functions through a simple web interface.

### SUMMARY

### Technical Problem

An object of the present specification is to provide an SDK service that offers a high degree of freedom in animal experimental analysis, enabling the user to select resources and customize and utilize functions in a desired manner.

The technical problems to be solved by the present specification are not limited to the above-mentioned technical problems, and other technical problems that are not mentioned will be clearly understood by those skilled in the art in the technical field to which the present specification belongs from the following detailed description of the specification.

### Technical Solution

According to an aspect of the present specification, there is provided a method for performing animal analysis through a software development kit (SDK) module in a terminal, which may include acquiring a token for server authentication through the Auth SDK; setting a resource of the server through an AI SDK Client based on the token, wherein the resource of the server includes a computing resource for the animal analysis; uploading a video to be subjected to the animal analysis to the server through a Data SDK; obtaining an analysis result of the video through an AI SDK; and storing the analysis result through the Data SDK.

In addition, the analysis result may include a 2D or 3D pose estimation result.

In addition, the Data SDK may synchronize data of the terminal with data of the server.

In addition, the method may further include setting a resource of the server through a UI SDK Client based on the token; and visualizing the analysis result through a UI SDK.

In addition, the method may further include setting an instrument and a region of interest in an experimental environment of the animal analysis through the UI SDK.

In addition, the method may further include setting a resource of the server based on the token through a Data SDK Client, wherein the resource of the server includes a storage resource; and downloading the analysis result from the server through the Data SDK.

In addition, the method may further include performing labeling of the video through the AI SDK when the accuracy of the analysis result is poor.

According to another aspect of the present specification, there is provided a terminal for performing animal analysis, through a software development kit (SDK) module, which may include an Auth SDK module configured to perform user authentication, and acquire a token for server access through a Resource Access Manager; a UI SDK module configured to visually represent a result of the animal analysis, and perform a component manipulation, a learning result visualization or an analysis result visualization function; an AI SDK module configured to perform labeling, learning, prediction and analysis functions for the animal analysis, including pose estimation and behavior analysis functions; and a Data SDK module configured to synchronize data between the terminal and the server, and store and retrieve data related to the animal analysis.

### Advantageous Effects

According to the embodiments of the present specification, it is possible to provide an SDK service that offers a high degree of freedom in animal experimental analysis, enabling the user to select resources and customize and utilize functions in a desired manner.

Effects that may be obtained in the present specification are not limited to the above-mentioned effects, and other effects that are not mentioned will be clearly understood by those skilled in the art in the technical field to which the present specification belongs from the following description.

### BRIEF DESCRIPTION OF THE DRAWINGS

FIG. 1 is a block diagram describing an electronic device related to the present specification.

FIG. 2 is a block diagram of an AI device according to an embodiment of the present specification.

FIG. 3 illustrates an animal experimental analysis system consisting of SDK modules to which the present specification may be applied.

FIG. 4 is an embodiment of the use of SDK function to which the present specification may be applied.

FIG. 5 is an embodiment of the use of UI SDK function to which the present specification may be applied.

FIG. 6 is an embodiment of the use of AI SDK function to which the present specification may be applied.

FIG. 7 is an embodiment of the use of Data SDK function to which the present specification may be applied.

The accompanying drawings, which are included as part of the detailed description to facilitate an understanding of the present specification, provide embodiments of the present specification and, together with the detailed description, explain the technical features of the present specification.

### MODE FOR CARRYING OUT THE INVENTION

Hereinafter, embodiments disclosed in the present specification will be described in detail with reference to the accompanying drawings, and the same or similar components will be given the same reference numerals regardless of the reference numeral and redundant description thereof will be omitted. The suffixes “module” and “unit” for components used in the following description are given or used interchangeably only in consideration of ease of description in preparing the specification, and do not have distinct meanings or roles from each other. In addition, in describing the embodiments disclosed in this specification, detailed descriptions of known related technologies will be omitted if they are deemed to obscure the gist of the embodiments disclosed in the present specification. In addition, it should be understood that the accompanying drawings are merely for facilitating understanding of the embodiments disclosed in the present specification, and are not intended to limit the technical concept disclosed in the present specification by the accompanying drawings, and include all alteration, equivalents, and substitutions included in the concept and technical scope of the present specification.

Terms including ordinal numbers such as first, second, etc. may be used to describe various components, but the components are not limited by the terms. These terms are only used for the purpose of distinguishing one component from another.

It will be understood that when a component is referred to as being “connected” or “coupled” to other component, it may be directly connected or coupled to the other component, but intervening components may also be present. In contrast, when a component is referred to as being “directly connected” or “directly coupled” to other component, it should be understood that there are no intervening components present.

The singular expressions “a,” “an,” and “the” include plural expressions unless the context clearly dictates otherwise.

In this application, it should be understood that terms such as “comprises” or “have” are intended to specify the presence of characteristics, numbers, steps, operations, components, parts, or combinations thereof described in the specification, but do not preclude in advance the possibility of the presence or addition of one or more other characteristics, numbers, steps, operations, components, parts, or combinations thereof.

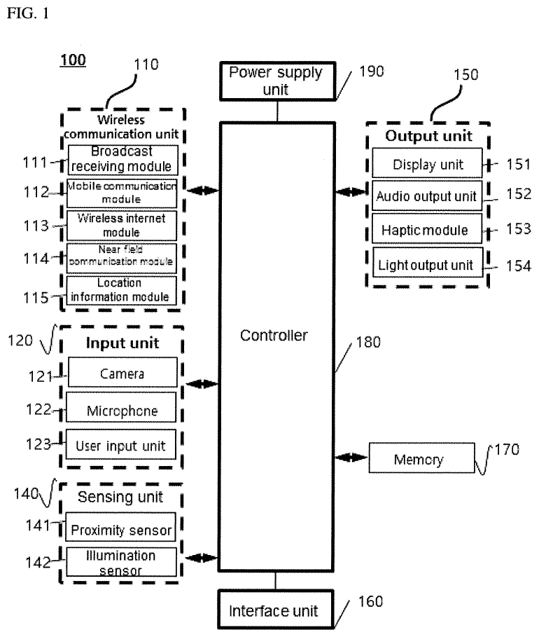

FIG. 1 is a block diagram describing an electronic device related to the present specification.

The electronic device 100 may include a wireless communication unit 110, an input unit 120, a sensing unit 140, an output unit 150, an interface unit 160, a memory 170, a controller 180, a power supply unit 190, and the like. The components shown in FIG. 1 are not essential for implementing the electronic device, so that the electronic device described herein may have more or fewer components than those listed above.

More specifically, the wireless communication unit 110 among the above components may include one or more modules that enable wireless communication between the electronic device 100 and a wireless communication system, between the electronic device 110 and other electronic device 100, or between the electronic device 100 and an external server. In addition, the wireless communication unit 110 may include one or more modules configured to connect the electronic device 100 to one or more networks.

The wireless communication unit 110 may include at least one of a broadcast receiving module 111, a mobile communication module 112, a wireless internet module 113, a near field communication module 114, and a location information module 115.

The input unit 120 may include a camera 121 or an video input unit for inputting video signals, a microphone 122 or an audio input unit for inputting audio signals, and a user input unit 123 (e.g., a touch key, a mechanical key, or the like) for receiving information from a user. The voice data or image data collected by the input unit 120 may be analyzed and processed as a control command from the user.

The sensing unit 140 may include one or more sensors for sensing at least one of information in the electronic device, surrounding environment information surrounding the electronic device, and user information. For example, the sensing unit 140 may include at least one of a proximity sensor 141, an illumination sensor 142, a touch sensor, an acceleration sensor, a magnetic sensor, a gravitation sensor (G-sensor), a gyroscope sensor, a motion sensor, an RGB sensor, an infrared sensor (IR sensor), a finger scan sensor, an ultrasonic sensor, an optical sensor (e.g., a camera; see reference numeral 121), a microphone (see reference numeral 122), a battery gauge, an environmental sensor (e.g., a barometer, a hygrometer, a thermometer, a radiation sensing sensor, a heat sensing sensor, a gas sensing sensor, or the like), and a chemical sensor (e.g., an electronic nose, a healthcare sensor, a biometric sensor, or the like). Meanwhile, the electronic device disclosed in the specification may utilize information sensed from at least two or more of these sensors in combination.

The output unit 150 is for generating output related to visual, auditory, tactile, or the like, and may include at least one of a display unit 151, an audio output unit 152, a haptic module 153, and a light output unit 154. The display 151 may form a mutual layer structure with the touch sensor or may be formed integrally with the touch sensor, thereby implementing a touchscreen. Such touchscreen may function as the user input unit 123 that provides an input interface between the electronic device 100 and user, and may simultaneously provide an output interface between the electronic device 100 and the user.

The interface unit 160 serves as a passage with various kinds of external devices connected to the electronic device 100. The interface unit 160 may include at least one of a wired/wireless headset port, an external charger port, a wired/wired data port, a memory card port, a port connecting a device provided with an identification module, an audio input/output (I/O) port, a video input/output (I/O) port and an earphone port. In the electronic device 100, in response to the external device being connected to the interface unit 160, appropriate control related to the connected external device may be performed.

In addition, the memory 170 stores data for supporting various functions of the electronic device 100. The memory 170 may store a plurality of application programs or applications driven on the electronic device 100, and data and instructions for operating the electronic device 100. At least some of these application programs may be downloaded from the external server via wireless communication. Also, at least some of these application programs may exist on the electronic device 100 from the time of release for basic functions of the electronic device 100 (e.g., incoming and outgoing call functions, message receiving and sending functions). Meanwhile, the application programs may be stored in the memory 170, installed on the electronic device 100, and driven by the controller 180 to perform an operation (or a function) of the electronic device.

In addition to operations related to the application program, the controller 180 typically controls overall operations of the electronic device 100. The controller 180 may provide or process appropriate information or function to the user by processing signals, data, information, or the like input or output through the above-described components or driving the application programs stored in the memory 170.

In addition, the controller 180 may control at least some of the components illustrated in conjunction with FIG. 1 in order to drive the application programs stored in the memory 170. Furthermore, the controller 180 may operate at least two or more of the components included in the electronic device 100 in combination with each other in order to drive the application programs.

The power supply unit 190, under the control of the controller 180, receives external power or internal power and supplies power to each of the components included in the electronic device 100. This power supply unit 190 includes a battery, and the battery may be an embedded battery or a battery in replaceable form.

At least some of the components may operate in cooperation with each other to implement the operation, control, or control method of the electronic device according to various embodiments described below. In addition, the operation, control, or control method of the electronic device may be implemented on the electronic device by driving at least one application program stored in the memory 170.

The electronic device 100 may be collectively referred to herein as the server, and the server may include a cloud server. In addition, the terminal may include all or some configurations of the electronic device 100, and may include a tablet PC.

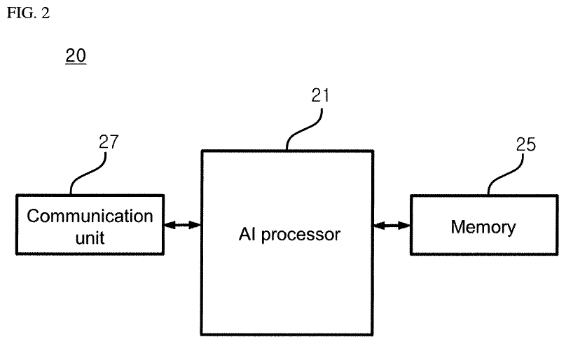

FIG. 2 is a block diagram of an AI device according to an embodiment of the present specification.

The AI device 20 may include an electronic device including an AI module capable of performing AI processing, a terminal including the AI module, or the like. The AI device 20 may also be included in at least some configurations of the electronic device 100 shown in FIG. 1 and may be provided to perform at least some of the AI processing together.

The AI device 20 may include an AI processor 21, a memory 25, and/or a communication unit 27.

The AI device 20 is a computing device capable of learning a neural network, and may be implemented as various electronic devices such as a terminal, a desktop PC, a notebook PC, a tablet PC, and the like.

The AI processor 21 may learn the neural network using a program stored in the memory 25. In particular, the AI processor 21 may include a large-scale pre-learned pose estimation model. For example, the pose estimation model may predict the main key-points of the target in a video frame acquired from the terminal in real time.

On the other hand, the AI processor 21 that performs the functions as described above may be a general-purpose processor (for example, a CPU), but may be an AI-only processor for artificial intelligence learning (for example, GPU, graphics processing unit).

The memory 25 may store various programs and data necessary for the operation of the AI device 20. The memory 25 may be implemented as a non-volatile memory, a volatile memory, a flash-memory, a hard disk drive (HDD), or a solid-state drive (SDD) and the like. The memory 25 is accessed by AI the processor 21, and reading/writing/modifying/deleting/updating and the like of data by the AI processors 21 may be performed. In addition, the memory 25 may store the neural network model (for example, a deep learning model) generated through a learning algorithm for data classification/recognition according to an embodiment of the present specification.

Meanwhile, the AI processor 21 may include a data learning unit that learns the neural network for data classification/recognition. For example, the data learning unit may learn the deep learning model by acquiring learning data to be used for learning and applying the acquired learning data to the deep learning model.

The communication unit 27 may send the AI processing result by the AI processor 21 to the external electronic device.

The external electronic device may include another terminal or a terminal.

Meanwhile, although the AI device 20 illustrated in FIG. 2 has been described as being functionally divided into the AI processor 21, the memory 25, the communication unit 27, and the like, the above-described components may be integrated into one module and may be referred to as an AI module or an artificial intelligence (AI) model.

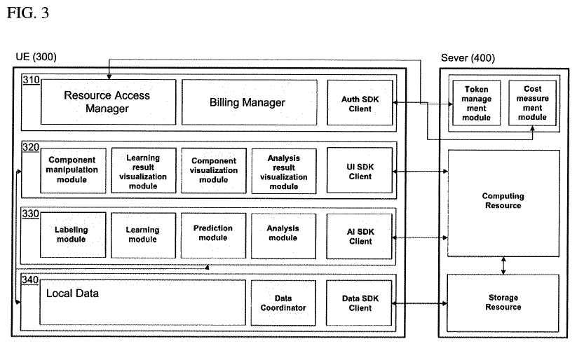

FIG. 3 illustrates an animal experimental analysis system consisting of SDK modules to which the present specification may be applied.

Referring to FIG. 3, an animal experimental analysis system may include a terminal 300 and a server 400. The server 400 may be implemented in the form of a cloud server.

A software development kit (SDK) refers to collections of software tools and libraries that are provided to enable specific functions to be easily implemented. The SDK assists developers in rapidly developing and extending applications without directly implementing the core functionality of the system. Generally, the SDK includes APIs, code samples, documents, development tools, and the like, and may be designed to allow smooth interaction with a specific platform or service. For example, an Auth SDK, UI SDK, AI SDK, and Data SDK are respectively responsible for authentication, visualization, AI-based data processing, and data management functions, and these modules may be organically connected to optimize functions of specific domains such as animal behavior analysis.

The terminal 300 may mean a client device on which the user uploads video data and receives an analysis result. For example, various devices such as a mobile device, a tablet, and a PC may serve as the terminal 310 and interact with the server 400 through a user interface (UI). When the user selects video and starts uploading, the terminal 300 may process video data in units of segments through the server 400 by using a streaming protocol.

The terminal 300 may include Auth SDK 310, UI SDK 320, AI SDK 330, and Data SDK 340.

The Auth SDK 310 may manage user authentication and access to server resources. In order for the user to access the system, user authentication is performed through the resource access manager, and a token is acquired in this process. This token may provide access to server resources, and cost measurements based on server usage may be made by the Billing Manager.

The Auth SDK Client may communicate with the server and verify the validity of the token or send a request to the server that is needed by the authenticated user. All SDK modules may access server resources based on permissions granted through the Auth SDK 310. The Auth SDK 310 is responsible for security and rights management throughout the service, and the user is free to access each function without additional authentication procedures.

The UI SDK 320 is a module that supports interaction and visualization between the user and the system. The user may edit the experimental data or manually manipulate the settings of the instruments and areas through the component manipulation module.

The learning result visualization module visualizes the data received from the Data SDK 340 so that the user may intuitively analyze the results. In addition, the analysis result visualization module may visually represent the pose data and the behavior analysis result to support the decision-making of the researcher. The UI SDK 320 may provide a user-friendly interface to facilitate manipulation of experimental data and review of visualized results without complex settings.

The AI SDK 330 is a module responsible for data learning, prediction, and analysis, and may perform model training and behavior analysis. For example, the labeling module may allow the user to label data or use an automatic labeling function to increase the efficiency of the labeling operation. The learning module may support supervised learning and self-supervised learning based on the user's dataset or the server dataset to optimize the performance of the model. The prediction module may perform pose estimation and/or 2D/3D pose reconstruction to predict the operation of the subject object. The analysis module provides various forms of analysis based on the movement, velocity, trajectory, etc. of the animal, and the results may be stored in the Data SDK 340 and visualized through the UI SDK 320.

The Data SDK 340 is a module that manages experimental data and synchronizes data between local and server 400. For example, the Data Coordinator may perform an operation of uploading data stored locally to a server as necessary or downloading server data locally. The stored data is managed in various forms such as the video file, a camera input, and a model result, and each SDK module may support retrieving or storing data whenever necessary. This flexible data management function increases the efficiency of the experimental environment.

In addition, the Data SDK 340 may manage all data flows of the system to provide data necessary for the learning and prediction process of the AI SDK 330, and facilitate visualization and result storage.

The server 400 is responsible for central resource management and computation of the system, and may support each SDK module to function smoothly. For example, the server 400 may include a token management module, a cost measurement module, a computing resource, and a storage resource.

The token management module may be responsible for granting access to the authenticated user based on the user authentication information. For example, upon receiving a request from the Auth SDK Client, it verifies the user information and acquires the token to allow server resource access.

This module continuously manages the acquired tokens and enables the user to access system resources only in an authenticated state through validation. This may ensure security and prevent service abuse.

The cost measurement module may be responsible for tracking the user's server resource usage amount and calculating the cost based thereon. The user may check the resource consumption amount for the task executed on the server, and the cost may be charged through that information.

For example, when a model learning of the AI SDK 330 or a visualization task of the UI SDK 320 is performed through the server 400, costs may be measured based on a used computing resource (GPU/CPU) and a storage usage amount. This process may be linked to the Billing Manager to provide the user with a clear cost scheme.

The computing resources may include CPUs and GPUs in the server to provide computational resources needed to perform tasks such as data processing and analysis, learning, and the like. The model learning, or prediction task, of the AI SDK 330 may utilize computing resources of the server to process large-scale data.

The storage resource may store and manage all data of the system, such as user data, models, analysis results, and the like. For example, a storage resource may be linked to the Data SDK 340 for synchronizing local data and server data to support uploading and downloading of data.

This allows experimental videos or labeled data to be stored on the server and accessed immediately when needed, which the user may visually review via the UI SDK 320. In addition, the model learning result is securely stored in the server, and may be reused for subsequent operations or analysis.

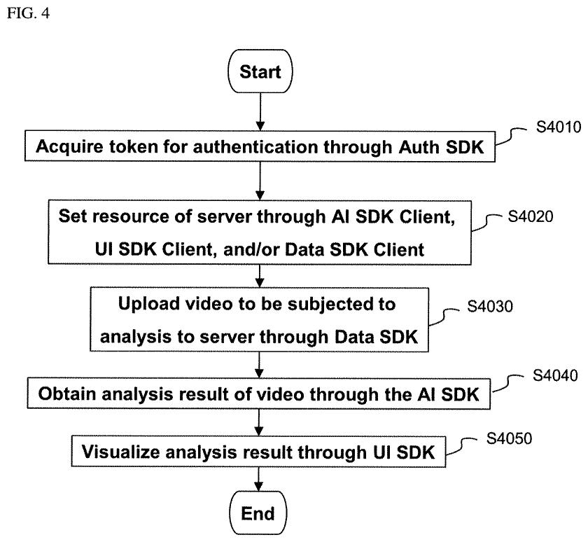

FIG. 4 is an embodiment of the use of SDK function to which the present specification may be applied.

Referring to FIG. 4, the user may utilize all functions provided on a server basis to use the SDK function for analysis of animal experiment data. In an embodiment described below with reference to FIGS. 4 to 6, if the user uses a local resource, the first step may be omitted, and the resource set in the second step may be set locally.

The terminal is acquired a token for authentication through the Auth SDK to use an analysis function provided by the server (S4010). For example, the user inputs an ID and a password to send an authentication request to the server through the terminal, and the server may acquire the token after verifying it. The acquired token may then be used as an authentication key for resource (e.g., computing and storage) access provided by the server.

Such token is required in SDK such as AI SDK, UI SDK, or Data SDK may use a server-based resource after user authentication is completed. In this way, the terminal may omit an unnecessary re-authentication procedure and ensure smooth data flow while maintaining security.

The terminal sets a resource of the server through AI SDK Client, UI SDK Client, and/or Data SDK Client based on the acquired token (S4020). For example, when the token is acquired, the user may set it to use server resources at each SDK Client. Basically, the SDK may be executed in the terminal and the server, and this step may include a process of setting the SDK to be executed in the server environment.

For example, the user may execute a command such as set_access_token (token, “server”) in AI SDK, UI SDK, or Data SDK, respectively, to set that the server-based resource is to be utilized. This setup allows AI computations, data storage, analysis and visualization tasks, etc., to be performed through the server.

The terminal uploads the video to be analyzed to the server through the Data SDK (S4030). For example, the user uploads the video of the non-clinical animal experiment to be analyzed to the server by using the Data SDK. This data is used as essential material to perform learning and prediction in the AI SDK, and may be visually reviewed through the UI SDK.

The Data SDK is responsible for data synchronization between the local and the server, so that when the user uploads the video, the video is stored in a storage resource of the server. The AI SDK and UI SDK then retrieve and use this data when needed.

When the terminal expects the video data to be slightly different from the existing AI model, the terminal may utilize a self-supervised learning function through a learning module of the AI SDK. In this process, the terminal may re-learn the AI model based on the dataset of the user, to generate a model more optimized for the experimental environment. When the learning is completed, the new model is stored in the server, and then may be used in an analysis and prediction process.

In addition, the terminal may recognize the mechanism of the animal experiment environment through the prediction module of the AI SDK. For example, there may be instruments (e.g., footsteps, obstacles, spatial compartments) in the experimental video, as well as the environment in which the animal is moving. The prediction module of the AI SDK may be used to automatically recognize such an instrument. The prediction module may be capable of sensing the instrument within the experimental environment and visually displaying it, via the UI SDK.

When automatic recognition is difficult, the user may directly set the instrument recognition by using an operation function provided by the UI SDK. This allows the position, size and shape of the instrument in the experimental environment to be directly set. Such operation function is visually provided, so that the user may intuitively adjust the experimental environment while viewing the video. When the operation is completed, the set information is stored through the Data SDK, and then may be utilized in the analysis and prediction step.

In addition, the user may wish to intensively analyze the behavior of an animal in a particular area. For example, when it is desired to analyze the time of stay in the specific spatial region or how often a particular area is traversed, the operation module of the UI SDK may be utilized to establish the region of interest. Using this function, the user may set the specific spatial region desired by the user (for example, an Open Arms region in the Open Arms Test), and then extract, through an analysis module of the AI SDK, behavior data based on the region.

The terminal obtains, through the AI SDK, an analysis result of the video (S4040). For example, the terminal may execute the prediction module of the AI SDK to perform pose estimation of an experimental target (for example, a mouse). This allows the AI model to track the movement of the animal in the experimental video to calculate a 2D or 3D Pose. If the pose data provided by the AI model is incorrect, a labeling operation of the video may be performed to correct it. The user may manually modify, through the terminal, the data, or use the automatic labeling function.

In particular, using real-time crowdsourcing, the terminal may also perform labeling through external personnel. For example, a large number of labeling operations may be performed in conjunction with an external service such as Amazon Mechanical Turk. The extracted Pose data is the main base material for behavioral analysis and epidemiological analysis, and this data may be stored in the Data SDK and visualized through the UI SDK.

The terminal may perform behavior analysis of the animal through the analysis module of the AI SDK. For example, the analysis result may include dynamic information such as a speed, a trajectory, a direction, an angular velocity, and an acceleration of the animal, interaction analysis with a specific instrument and area, behavior pattern classification based on pose clustering, or specific behavior (for example, walking, sleeping time, and a specific movement) detection information, and the like.

The terminal visualizes the analysis result through the UI SDK (S4050). For example, the terminal may graphically display the analysis result to the user by using the visualization module of the UI SDK. This allows the user to ascertain the results of an intuitive analysis based on the experimental video, rather than merely numerical data. This visualization may also be stored as the image file, such as PNG, JPG, SVG, for use by the researcher in writing articles or reporting. Analytical results may be archived through Data SDK and may be retrieved again as needed.

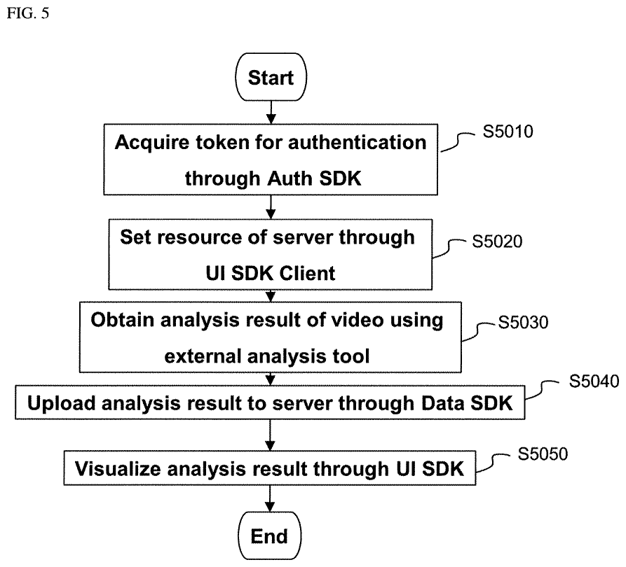

FIG. 5 is an embodiment of the use of UI SDK function to which the present specification may be applied.

Referring to FIG. 5, the user may visually represent the directly analyzed data by using the UI SDK and check the result.

The terminal is acquired the token for authentication through the Auth SDK (S5010).

Then, the terminal sets the resource of the server through the UI SDK Client (S5020). When the token is acquired, the terminal may set the UI SDK to use the server-based resource. For example, the terminal may set the UI SDK and the Data SDK respectively to allow the server access. The UI SDK may then retrieve the data stored on the server, or store new data when needed, and the user may use the high-performance visualization function utilizing the server.

The terminal obtains an analysis result of the video using the external analysis tool (S5030). For example, the user may perform pose estimation using deeplabcut, or utilize ethovision to analyze specific behavior patterns. The data thus obtained may be uploaded to the server for utilization in the UI SDK through the Data SDK. The user may utilize this to proceed with a more sophisticated visual analysis.

The terminal uploads the analysis result to the server through the Data SDK (S5040). For example, the Data Coordinator may synchronize the local data of the terminal with the server data, and the terminal may retrieve and visually analyze the stored data when needed.

The terminal visualizes the analysis result through the UI SDK (S5050). For example, the terminal may utilize the component visualization module of the UI SDK based on the uploaded analysis result to display the experiment data with the video to the user. The user may verify that the pose data has been extracted correctly, and modify the data when necessary.

The UI SDK may visually represent not only simple data but also behavior analysis and behavior recognition results together with a graph. This allows the user to identify specific behavioral patterns of the experimental animals and utilize them in the preparation of reports or articles. Utilizing UI SDK functionality, users may interpret experimental data in a more meaningful way, helping researchers make more effective decisions.

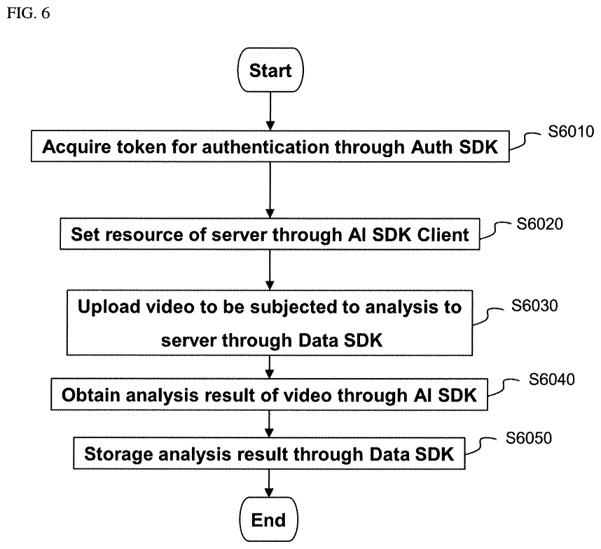

FIG. 6 is an embodiment of the use of AI SDK function to which the present specification may be applied.

Referring to FIG. 6, the terminal may analyze the experimental video by utilizing the Pose Estimation function of the AI SDK.

The terminal is acquired the token for authentication through the Auth SDK (S6010).

Then, the terminal sets the resource of the server through the AI SDK Client (S6020). For example, the terminal may set the token to enable the AI SDK to run on the server, so as to utilize server resources (computing resources). This enables the pose estimation function or the analysis function of the AI SDK to work and perform server-based operations.

The terminal uploads the video to be subjected to analysis to the server through the Data SDK (S6030). The user may upload an experimental video for performing pose estimation to the server through the Data SDK.

The terminal obtains the analysis result of the video through the AI SDK (S6040). For example, the terminal may execute the Pose Estimation model of the AI SDK based on the uploaded data, to extract the 2D or 3D Pose of the experimental animal. The results of this analysis may then be utilized to perform additional behavioral analysis or behavioral recognition tasks, allowing precise tracking of the movement of animals in the experimental environment.

Alternatively, the user may extract pose data from the video utilizing external tools such as deeplabcut or ethovision, and utilize the data in the analysis functions of the AI SDK to obtain analysis results.

The terminal stores the analysis result through the Data SDK (S6050). For example, the analysis result generated in the AI SDK may be stored in the server through the Data SDK, and then may be retrieved by the user when needed. This data may be visualized in the UI SDK, utilized for further analysis, and downloaded locally as needed.

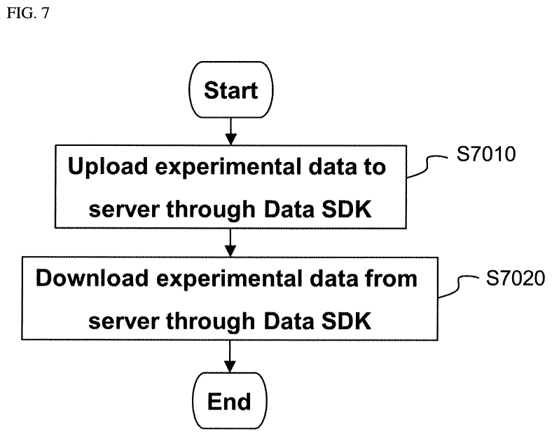

FIG. 7 is an embodiment of the use of Data SDK function to which the present specification may be applied.

Referring to FIG. 7, the user may upload/download experimental data to a server (cloud) for utilization.

The terminal uploads the experiment data to the server through the Data SDK (S7010). For example, the user may utilize the Data SDK to upload the experimental data to the server. This data may then be retrieved and analyzed when needed.

The terminal downloads the experiment data from the server through the Data SDK (S7020). For example, the user may download and analyze data stored on a server locally through a Data SDK. Through this process, the user may flexibly manage the experimental data and utilize it immediately when needed.

The following Table 1 is an example of SDK usage to which the present specification may be applied.

TABLE 1
# Retrieving SDK module individually
import actnova_auth
import actnova_ai
import actnova_ui
importactnova_data
# Execute in local environment
model = actnova_ai.PoseEstimation.initialize(device=″CPU″) # initialize
model with CPU or GPU
model.train(dataset=″custom_dataset″) # learne model with user dataset
result = model.predict(image) # perform prediction with image data
actnova_ui.visualize(result) # visualize prediction result
actnova_data.save(″my_model.pt″, model) # store the learned model locally
# Execute in server environment
my_token = actnova_auth.request_token(id=″...″, pw=″...″) # acquire token
actnova_ai.set_access_token(my_token, ″server″) # set server access
actnova_ui.set_access_token(my_token, ″server″)
actnova_data.set_access_token(my_token, ″server″)
model = actnova_ai.PoseEstimation.initialize(device=″server″) # initialize
model on server
model.train(dataset=″custom_dataset″) # learn model on server
result = model.predict(image) # perform prediction on server
actnova_ui.visualize(result) # server-based visualization
actnova_data.save(″server:my_model.pt″, model) # store learned model on
server

Referring to Table 1, each SDK (Auth, AI, UI, Data) is provided as a separate library, and the required functions may be called module by module. The user may call actnova_auth, actnova_ai, actnova_ui, actnova_data through the terminal to use each function independently.

In the terminal (local environment), after the model may be learned by the CPU/GPU and prediction may be performed, visualization may be performed, and the learned model may be stored. On the other hand, in the server environment, after authentication is performed by using request_token ( ), set_access_token ( ) may be set to utilize server resources in each SDK, then model learning and prediction are performed on the server, and the result may be stored in the server storage.

The following Table 2 is another example of SDK usage to which the present specification may be applied.

TABLE 2
# Use integratedSDK
import actnova
# Execute in local environment
model = actnova.PoseEstimation.initialize(device=″CPU″) # initialize
model with CPU orGPU
model.train(dataset=″custom_dataset″) # learn model locally
result = model.predict(image) # store result after prediction is performed
result.visualize( ) # visualize prediction result
model.save(″my_model.pt″) # store model locally
# Execute in server environment
actnova.set_access_token(″xn23-35kk-12mt-4ktg″) # set server usage
after tokenacquirement
model = actnova.PoseEstimation.initialize(device=″server″) # initialize
model on server
model.train(dataset=″custom_dataset″) # learn model on server
result = model.predict(image) # return result after performing prediction on
server
result.visualize( ) # server-based visualization
model.save(″server:my_model.pt″) # Save learned model to server

Referring to Table 2, the SDK uses a single library (actnova), so that all SDKfunctions may be managed in one module. This increases the simplicity of the code and eliminates the need to use separate SDK, which is a user-friendly approach.

For example, the terminal (local environment) may call actnova.PoseEstimation.initialize( ) to initialize a model, and perform learning and prediction through train( ), predict( ). The result may be visualized with visualize( ) and stored via save( ). In the server environment, the token may be set using set_access_token ( ) and then learning and prediction may be performed in the same process.

This approach increases the flexibility of using SDK and makes it particularly accessible to novice developers.

The foregoing specification may be implemented as computer-readable code on a medium in which a program is recorded. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, an optical data storage device, and the like, and also include those implemented in the form of a carrier wave (e.g., send through the internet). Accordingly, the above detailed description should not be construed as limiting in all aspects but should be considered as illustrative. The scope of the present specification should be determined by a reasonable interpretation of the appended claims, and all changes within the equivalent scope of the present specification are intended to be included in the scope of the present specification.

In addition, although the foregoing description has been made with reference to services and embodiments, it is merely illustrative and not intended to limit the present specification, and it will be understood by those skilled in the art to which this specification pertains that various modifications and applications not exemplified above are possible without departing from the essential characteristics of the services and embodiments. For example, each component specifically shown in the embodiments may be modified and implemented. And such differences relating to the modifications and applications shall be construed as being included in the scope of the present specification as defined by the appended claims.

What is claimed is:

1. A method for performing animal analysis through a software development kit (SDK) module in a terminal, comprising:
acquiring a token for server authentication through the Auth SDK;
setting a resource of the server through an AI SDK Client based on the token, wherein the resource of the server comprises a computing resource for the animal analysis;
uploading a video to be subjected to the animal analysis to the server through a Data SDK;
obtaining an analysis result of the video through an AI SDK; and
storing the analysis result through the Data SDK.

2. The animal analysis method of claim 1, wherein the analysis result comprises a 2D or 3D pose estimation result.

3. The animal analysis method of claim 2, wherein the Data SDK synchronizes data of the terminal with data of the server.

4. The animal analysis method of claim 3, further comprising:
setting a resource of the server through a UI SDK Client based on the token; and
visualizing the analysis result through a UI SDK.

5. The animal analysis method of claim 4, further comprising:
setting an instrument and a region of interest in an experimental environment of the animal analysis through the UI SDK.

6. The animal analysis method of claim 3, further comprising:
setting a resource of the server based on the token through a Data SDK Client, wherein the resource of the server comprises a storage resource; and
downloading the analysis result from the server through the Data SDK;

7. The animal analysis method of claim 3, further comprising:
performing labeling of the video through the AI SDK when the accuracy of the analysis result is poor.

8. A terminal for performing animal analysis, through a software development kit (SDK) module, comprising:
an Auth SDK module configured to perform user authentication, and acquire a token for server access through a Resource Access Manager;
a UI SDK module configured to visually represent a result of the animal analysis, and perform a component manipulation, a learning result visualization or an analysis result visualization function;
an AI SDK module configured to perform labeling, learning, prediction and analysis functions for the animal analysis, comprising pose estimation and behavior analysis functions; and
a Data SDK module configured to synchronize data between the terminal and the server, and store and retrieve data related to the animal analysis.
